(19) United States
(12) Patent Application Publication
(10) Pub. No.: US 2025/0133594 A1
(43) Pub. Date: Apr. 24, 2025

(54) WIRELESS COMMUNICATION DEVICE AND METHOD

(71) Applicant: MEDIATEK INC., Hsinchu City (TW)

(72) Inventor: Yang-Hung Peng, Hsinchu City (TW)

(21) Appl. No.: 18/918,296

(22) Filed: Oct. 17, 2024

Related U.S. Application Data
(60) Provisional application No. 63/591,138, filed on Oct. 18, 2023.

(51) Int. Cl. H04W 74/0816; H04W 8/22; H04W 74/08

(52) U.S. Cl. CPC H04W 74/0816; H04W 8/22; H04W 74/0891

(57) ABSTRACT

A multi-link operation wireless communication method and device are disclosed. A first synchronization information from the first wireless communication control circuit is received by the second wireless communication control circuit. The first synchronization information includes a first updated status of a first packet queue and an end time of a first transmission packet transmitted by the first wireless communication control circuit over a first link. The second wireless communication control circuit generates a synchronization collision period based on the end time of the first transmission packet. The second wireless communication control circuit aggregates data packets into a second transmission packet transmitted over a second link. The second wireless communication control circuit adjusts an end time of the second transmission packet as either before a start of the synchronization collision period or after an end of the synchronization collision period.

This application claims the benefit of U.S. Provisional Patent application Ser. No. 63/591,138, filed Oct. 18, 2023, the disclosure of which is incorporated by reference herein in its entirety.

### TECHNICAL FIELD

The disclosure relates to a wireless communication device and method.

### BACKGROUND

In Wi-Fi systems, multi-link operation (MLO) is a feature that allows devices to use multiple wireless links simultaneously for communication. This capability is primarily introduced in Wi-Fi 7 (also known as 802.11be) and aims to improve performance by utilizing multiple frequency bands (e.g., 2.4 GHZ, 5 GHz, and 6 GHZ) at the same time.

Key benefits of multi-link operation are as follows. (1) Increased Throughput: By using multiple links concurrently, MLO can increase the data transmission rate, offering significantly higher speeds compared to previous Wi-Fi standards. (2) Improved Reliability: If one link experiences interference or degradation in performance, the system can switch or offload traffic to another link, ensuring more stable connectivity. (3) Lower Latency: MLO can reduce delays by allowing data packets to be transmitted via multiple paths, decreasing waiting times and enhancing the user experience in latency-sensitive applications like gaming, AR/VR, and video conferencing. (4) Better Spectrum Efficiency: Since MLO operates across multiple bands, it can balance the load more efficiently, optimizing the use of available spectrum.

How MLO Works is described. (1) Parallel Usage of Channels: Devices supporting MLO can transmit and receive data over different channels and frequency bands at the same time, increasing the overall throughput and flexibility. (2) Seamless Switching: MLO can dynamically manage connections, enabling smooth handoffs between links in case one link becomes unstable or less optimal. (3) Load Balancing: MLO can allocate traffic to different links based on their availability and performance, ensuring a balanced and efficient distribution of network load.

Wi-Fi 7's MLO feature is set to dramatically enhance wireless communication by boosting both speed and reliability in multi-device and high-demand environments. Wi-Fi 7's MLO feature is applicable on many devices, such as access-point (AP), stations, smart homes or Internet of Things (IoT) ecosystems, where multiple devices compete for bandwidth.

For MLO TX (transmission), a MPDU (MAC (Media Access Control) Protocol Data Unit) queue status is updated after MPDU aggregation or receiving corresponding BA (block acknowledgement). For a multi-chip MLO system, when the MPDU queue status is updated on one chip, it needs to be synchronized to other chips. The synchronization needs to be done before any of other chips starts the aggregation for next TX. In prior art, high performance inter-chip interface is needed to synchronize the queue status, which is high cost.

Thus, there needs a multi-chip MLO wireless communication device and method which can synchronize the MPDU queue status before any of other chips starts the aggregation for next TX even when a middle performance (middle cost) inter-chip interface is used.

### SUMMARY

According to one embodiment, a multi-link operation wireless communication method applicable to a wireless communication device having a first wireless communication control circuit and a second wireless communication control circuit is provided. The multi-link operation wireless communication method comprises: receiving a first synchronization information from the first wireless communication control circuit to the second wireless communication control circuit, the first synchronization information including a first updated status of a first packet queue of the first wireless communication control circuit and an end time of a first transmission packet to be transmitted by the first wireless communication control circuit over a first link; generating a synchronization collision period by the second wireless communication control circuit based on the end time of the first transmission packet; and aggregating, by the second wireless communication control circuit, a plurality of data packets into a second transmission packet which is transmitted over a second link, wherein the second wireless communication control circuit adjusts an end time of the second transmission packet as either before a start of the synchronization collision period or after an end of the synchronization collision period.

According to another embodiment, a multi-link operation wireless communication device is provided. The multi-link operation wireless communication device includes: a first wireless communication control circuit, and a second wireless communication control circuit coupled to the first wireless communication control circuit. Both the first and the second wireless communication control circuits are configured for: receiving a first synchronization information from the other one among the first and the second wireless communication control circuits, the first synchronization information including a first updated status of a first packet queue and an end time of a first transmission packet to be transmitted by either the first wireless communication control circuit over a first link or the second wireless communication control circuit over a second link; generating a synchronization collision period based on the end time of the first transmission packet; and aggregating a plurality of data packets into a second transmission packet which is transmitted over the second link, wherein an end time of the second transmission packet is adjusted to be either before a start of the synchronization collision period or after an end of the synchronization collision period.

### BRIEF DESCRIPTION OF THE DRAWINGS

FIG. 1 shows MLO single-chip transmission. In FIG. 1, the single chip handles both a first link and a second link.

FIG. 2 shows MLO multi-chip transmission.

FIG. 3 shows MLO multi-chip transmission without synchronization collision.

FIG. 4 shows MLO multi-chip transmission with synchronization collision.

FIG. 5 shows an example of MLO multi-chip transmission according to one embodiment of the application.

FIG. 6 shows another example of MLO multi-chip transmission according to one embodiment of the application.

FIG. 7 shows a block diagram of a wireless communication device according to one embodiment of the application.

FIG. 8 shows a wireless communication method according to one embodiment of the application, wherein the PPDU end time is adjusted to be before the start of the synchronization collision period for avoiding synchronization collisions.

FIG. 9 shows a wireless communication method according to one embodiment of the application, wherein the PPDU end time is adjusted to be after the end of the synchronization collision period for avoiding synchronization collisions.

FIG. 10A and FIG. 10B show a wireless communication method according to one embodiment of the application, wherein the PPDU end time is adjusted to be either before the start of the synchronization collision period or after the end of the synchronization collision period for avoiding synchronization collisions.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

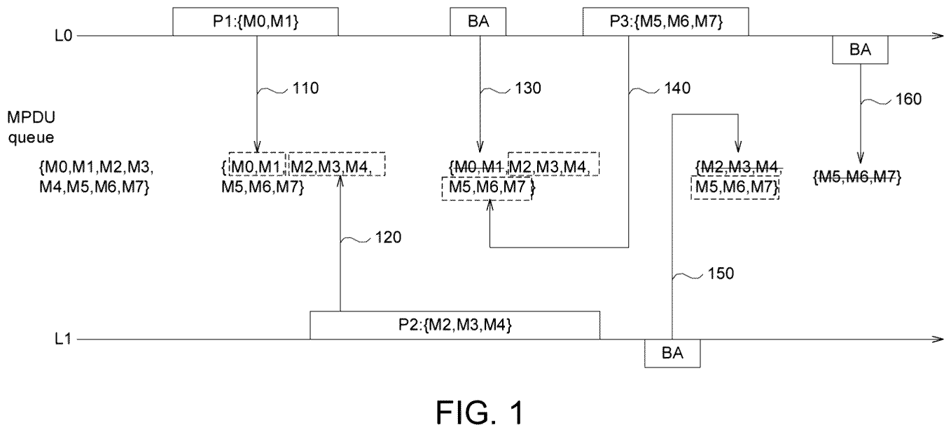

FIG. 1 shows MLO single-chip transmission. In FIG. 1, the single chip handles both a first link L0 (for example but not limited by, 2.4G) and a second link L1 (for example but not limited by, 5G). MPDU queue may queue several MPDU which is to be transmitted over the links L0 or L1. FIG. 1 shows eight MPDUs M0, M1, . . . , M7 queue in the MPDU queue.

At step 110, the chip (not shown) aggregates the MPDUs M0 and M1 into a first PPDU (Physical Layer Protocol Data Unit) P1 for transmission over the first link L0 and thus the chip updates the MPDU queue status by holding the MPDUs M0 and M1. In here, “holding the MPDU” means that the MPDU is selected to be aggregated by the chip for transmission.

Similarly, at step 120, the chip aggregates the MPDUs M2, M3 and M4 into a second PPDU P2 for transmission over the second link L1 and thus the chip updates the MPDU queue status by holding the MPDUs M2, M3 and M4.

At step 130, after the first PPDU P1 (aggregating the MPDUs M0 and M1) is successfully received, the chip receives the BA and thus the chip updates the MPDU queue status by releasing the MPDUs M0 and M1.

At step 140, the chip aggregates the MPDUs M5, M6 and M7 into a third PPDU P3 for transmission over the first link L0 and thus the chip updates the MPDU queue status by holding the MPDUs M5, M6 and M7.

At step 150, after the second PPDU P2 (aggregating the MPDUs M2, M3 and M4) is successfully received, the chip receives the BA and thus the chip updates the MPDU queue status by releasing the MPDUs M2, M3 and M4.

At step 160, after the third PPDU P3 (aggregating the MPDUs M5, M6 and M7) is successfully received, the chip receives the BA and thus the chip updates the MPDU queue status by releasing the MPDUs M5, M6 and M7.

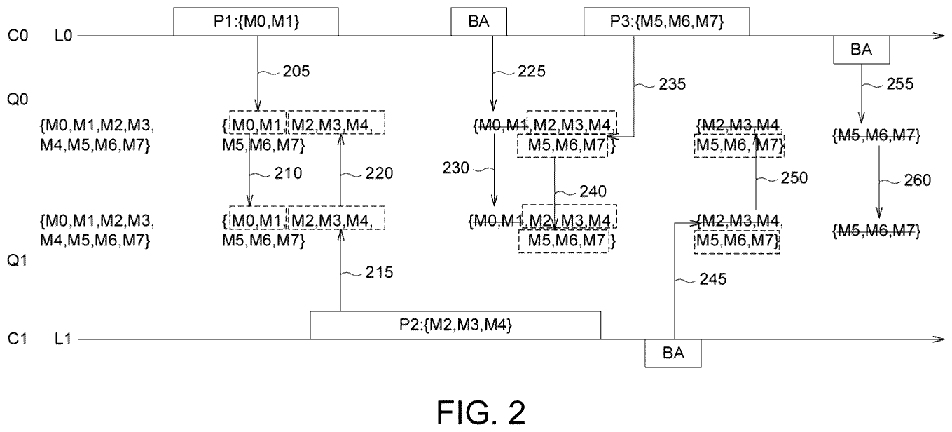

FIG. 2 shows MLO multi-chip transmission. In FIG. 2, the first chip C0 handles the first link L0 and the second chip C1 handles the second link L1. The first MPDU queue Q0 is managed by the first chip C0 while the second MPDU queue Q1 is managed by the second chip C1.

At step 205, the first chip C0 aggregates the MPDUs M0 and M1 into a first PPDU P1 for transmission over the first link L0 and thus the first chip C0 updates status of the first MPDU queue Q0 by holding the MPDUs M0 and M1.

At step 210, the first chip C0 sends the status of the first MPDU queue Q0 to the second chip C1 and thus the second chip C1 synchronously updates the statue of the second MPDU queue Q1 by holding the MPDUs M0 and M1.

At step 215, the second chip C1 aggregates the MPDUs M2, M3 and M4 into a second PPDU P2 for transmission over the second link L1 and thus the second chip C1 updates status of the second MPDU queue Q1 by holding the MPDUs M2, M3 and M4.

At step 220, the second chip C1 sends the status of the second MPDU queue Q1 to the first chip C0 and thus the first chip C0 synchronously updates the statue of the first MPDU queue Q0 by holding the MPDUs M2, M3 and M4.

At step 225, after the first PPDU P1 (aggregating the MPDUs M0 and M1) is successfully received, the first chip C0 receives the BA and thus the first chip C0 updates status of the first MPDU queue Q0 status by releasing the MPDUs M0 and M1.

At step 230, the first chip C0 sends the status of the first MPDU queue Q0 to the second chip C1 and thus the second chip C1 synchronously updates the statue of the second MPDU queue Q1 by releasing the MPDUs M0 and M1.

Steps of 235-260 are similar and thus are omitted here.

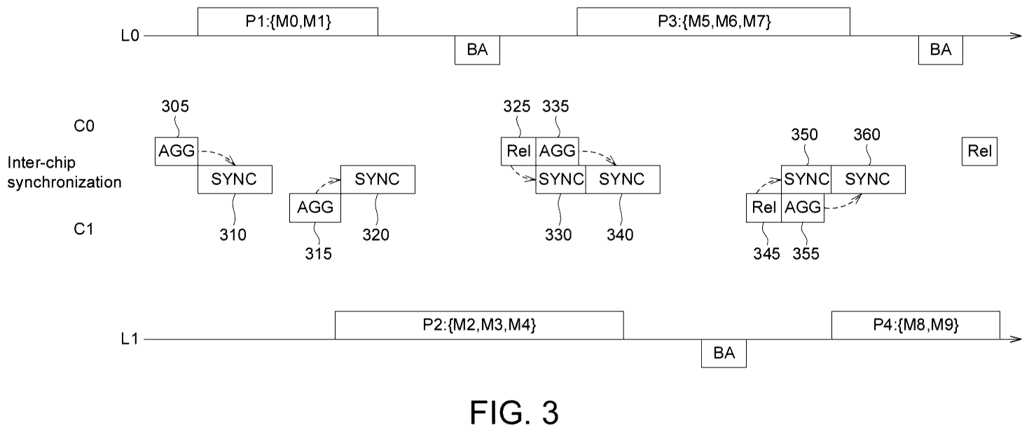

FIG. 3 shows MLO multi-chip transmission without synchronization collision. FIG. 3 shows operations on the chips C0 and C1, and inter-chip synchronization between the chips C0 and C1.

At step 305, the first chip C0 aggregates the MPDUs M0 and M1 into a first PPDU P1 for transmission over the first link L0.

At step 310, the first chip C0 updates status of the first MPDU queue Q0 to the second chip C1 by holding the MPDUs M0 and M1. That is, at step 310, an inter-chip synchronization is performed to synchronously update status of the first MPDU queue Q0 and the second MPDU queue Q1 by holding the MPDUs M0 and M1.

At step 315, the second chip C1 aggregates the MPDUs M2, M3 and M4 into a second PPDU P2 for transmission over the second link L1.

At step 320, the second chip C1 updates status of the second MPDU queue Q1 to the first chip C0 by holding the MPDUs M2, M3 and M4. That is, at step 320, an inter-chip synchronization is performed to synchronously update status of the first MPDU queue Q0 and the second MPDU queue Q1 by holding the MPDUs M2, M3 and M4.

At step 325, after the first PPDU P1 (aggregating the MPDUs M0 and M1) is successfully received, the first chip C0 receives the BA and thus the first chip C0 updates status of the first MPDU queue Q0 status by releasing the MPDUs M0 and M1.

At step 330, the first chip C0 updates status of the first MPDU queue Q0 to the second chip C1 by releasing the MPDUs M0 and M1. That is, at step 330, an inter-chip synchronization is performed to synchronously update status of the first MPDU queue Q0 and the second MPDU queue Q1 by releasing the MPDUs M0 and M1.

Steps of 335-360 are similar and thus are omitted here.

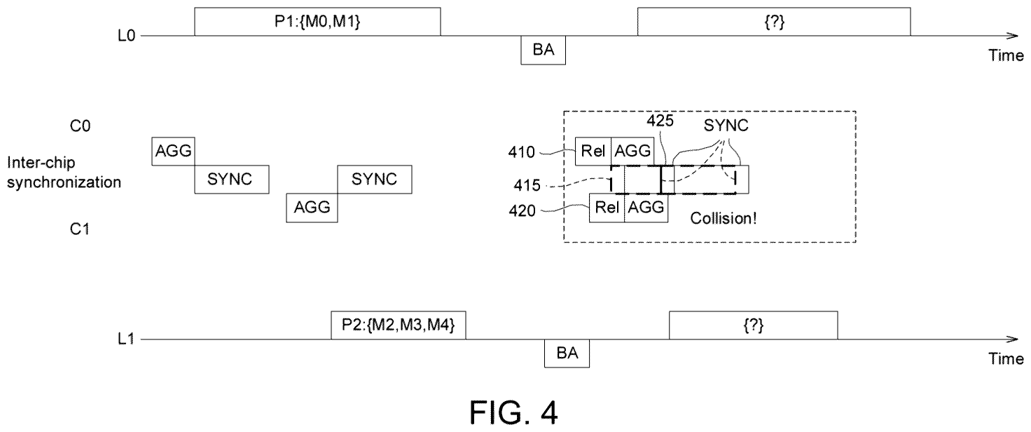

FIG. 4 shows MLO multi-chip transmission with synchronization collision. For simplicity, steps before step 410 are omitted.

At step 410, after the first PPDU P1 (aggregating the MPDUs M0 and M1) is successfully received, the first chip C0 receives the BA and thus the first chip C0 updates status of the first MPDU queue Q0 status by releasing the MPDUs M0 and M1.

At step 415, an inter-chip synchronization is performed to synchronously update status of the first MPDU queue Q0 and the second MPDU queue Q1 by releasing the MPDUs M0 and M1.

At step 420, after the second PPDU P2 (aggregating the MPDUs M2, M3 and M4) is successfully received, the second chip C1 receives the BA and thus the second chip C1 updates status of the second MPDU queue Q1 by releasing the MPDUs M2, M3 and M4.

At step 425, an inter-chip synchronization is performed to synchronously update status of the first MPDU queue Q0 and the second MPDU queue Q1 by releasing the MPDUs M2, M3 and M4.

However, as shown in FIG. 4, the inter-chip synchronization steps 415 and 425 are collided. That is, before the inter-chip synchronization step 415 is completed, another inter-chip synchronization step 425 has to be performed.

Due to inter-chip synchronization collision, the status of the first MPDU queue Q0 and the second MPDU queue Q1 are not synchronized (i.e. the status of the first MPDU queue Q0 and the second MPDU queue Q1 are not the same). Therefore, after inter-chip synchronization collision, the first and the second chips have to wait until inter-chip synchronization is completed, and this may cause further time cost. Because of the timing constraint of Wi-Fi standards (wherein the interval must be a SIFS), the MLO multi-chip transmission device may either give up transmission of one link, or transmit useless data over one link in case of inter-chip synchronization collision.

In brief, in one embodiment of the application in order to complete inter-chip synchronization before any of other chips starts the aggregation for next TX, the length of the PPDUs transmitted on different chips is adjusted so the end time of the PPDUs is staggered. Therefore, the time for synchronizing the MPDU queue status is staggered. In this way, the Multi-chip MLO system doesn't need a high performance inter-chip interface to synchronize the MPDU queue status.

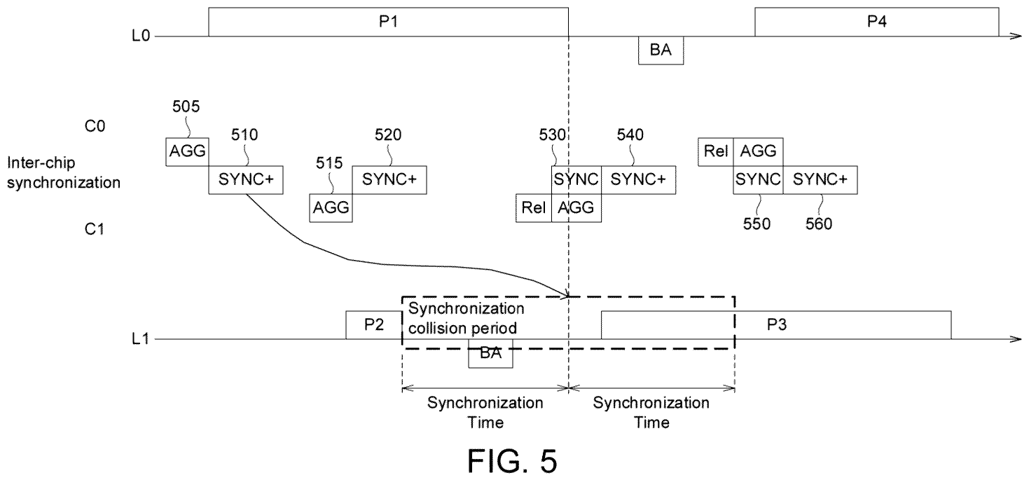

FIG. 5 shows an example of MLO multi-chip transmission according to one embodiment of the application.

At step 505, the first chip C0 aggregates the MPDUs (for example M0 and M1) into a first PPDU P1 for transmission over the first link L0. In the following, the MPDU also be referred as data packets while the PPDU as transmission packets.

At step 510, the first chip C0 updates status of the first MPDU queue Q0 to the second chip C1 by holding the MPDUs (M0 and M1) and the first chip C0 also informs to the second chip C1 about the end time of the first PPDU P1. That is, at step 510, an inter-chip synchronization is performed to synchronously update status of the first MPDU queue Q0 and the second MPDU queue Q1 by holding the MPDUs M0 and M1 and identifying the end time of the first PPDU P1. At step 510, the synchronization information sent from the first chip C0 to the second chip C1 includes the updated status of the first MPDU queue Q0 and the end time of the first PPDU P1 transmitted by the first chip C0.

After the second chip C1 obtains the end time of the first PPDU P1, the second chip C1 estimates the synchronization time that the second chip C1 will take to complete inter-chip synchronization based on the second chip C1's hardware capabilities (such as hardware clock rate and so on). This allows the second chip C1 to determine the synchronization collision period. The synchronization collision period is centered by the end time of the first PPDU P1, while the length of synchronization collision period is two times of the synchronization time. That is, the synchronization collision period is determined based on the PPDU end time and the hardware capabilities (such as hardware clock rate and so on) of the chips.

Subsequently, when the second chip C1 is preparing for aggregating the MPDUs into a second PPDU P2, the second chip C1 has to prevent from the end time of the second PPDU P2 falling within the synchronization collision period. In other words, the end time of the second PPDU P2 should either be before the start of the synchronization collision period or after the end of the synchronization collision period. With this adjustment, the inter-chip synchronization time of the second chip C1 can be staggered from the inter-chip synchronization time of the first chip C0.

On the contrary, if the end time of the second PPDU P2 falls within the synchronization collision period, the inter-chip synchronization time of the second chip C1 may be overlapped with the inter-chip synchronization time of the first chip C0, as shown in the inter-chip synchronization collision in FIG. 4 where the inter-chip synchronization steps 415 and 425 are collided.

At step 515, the second chip C1 aggregates the MPDUs (for example M2) into a second PPDU P2 for transmission over the second link L1 wherein the end time of the second PPDU P2 is before the start of the synchronization collision period.

At step 520, the second chip C1 updates status of the second MPDU queue Q0 to the second chip C1 by holding the MPDUs (M0 and M1) and the second chip C1 also informs to the first chip C0 about the end time of the second PPDU P2. That is, at step 520, an inter-chip synchronization is performed to synchronously update status of the first MPDU queue Q0 and the second MPDU queue Q1 by holding the MPDUs (M2) and identifying the end time of the second PPDU P2.

In FIG. 5, after adjustment of the end time of the PPDU, the inter-chip synchronization steps 530 and 540 by the second chip C1 are staggered from the inter-chip synchronization steps 550 and 560 by the first chip C0.

In FIG. 5, the PPDU end time may be adjusted by changing MPDU counts, padding or any valid mechanism.

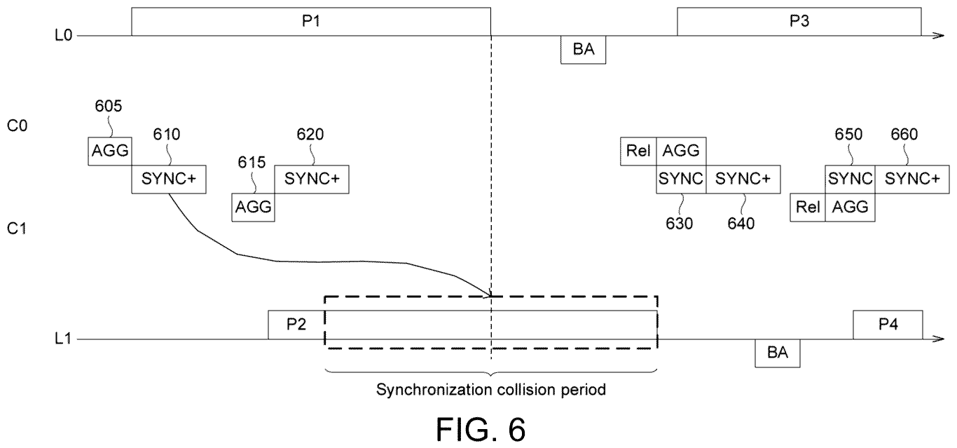

FIG. 6 shows another example of MLO multi-chip transmission according to one embodiment of the application.

At step 605, the first chip C0 aggregates the MPDUs (for example M0 and M1) into a first PPDU P1 for transmission over the first link L0.

At step 610, the first chip C0 updates status of the first MPDU queue Q0 to the second chip C1 by holding the MPDUs (M0 and M1) and the first chip C0 also informs to the second chip C1 about the end time of the first PPDU P1. That is, at step 610, an inter-chip synchronization is performed to synchronously update status of the first MPDU queue Q0 and the second MPDU queue Q1 by holding the MPDUs M0 and M1 and identifying the end time of the first PPDU P1.

After the second chip C1 obtains the end time of the first PPDU P1, the second chip C1 estimates the synchronization time that the second chip C1 will take to complete inter-chip synchronization based on the second chip C1's capabilities (such as hardware clock rate and so on). This allows the second chip C1 to determine the synchronization collision period. The synchronization collision period is centered by the end time of the first PPDU P1, while the length of synchronization collision period is two times of the synchronization time.

Subsequently, when the second chip C1 is preparing for aggregating the MPDUs into a second PPDU P2, the second chip C1 has to prevent from the end time of the second PPDU P2 falling within the synchronization collision period. In other words, the end time of the second PPDU P2 should either be before the start of the synchronization collision period or after the end of the synchronization collision period. With this adjustment, the inter-chip synchronization time of the second chip C1 can be staggered from the inter-chip synchronization time of the first chip C0.

On the contrary, if the end time of the second PPDU P2 falls within the synchronization collision period, the inter-chip synchronization time of the second chip C1 may be overlapped with the inter-chip synchronization time of the first chip C0, as shown in the inter-chip synchronization collision in FIG. 4 where the inter-chip synchronization steps 415 and 425 are collided.

At step 615, the second chip C1 aggregates the MPDUs (for example M2, M3 and M4) into a second PPDU P2 for transmission over the second link L1 wherein the end time of the second PPDU P2 is after the end of the synchronization collision period.

At step 620, the second chip C1 updates status of the second MPDU queue Q0 to the second chip C1 by holding the MPDUs (M0 and M1) and the second chip C1 also informs to the first chip C0 about the end time of the second PPDU P2. That is, at step 620, an inter-chip synchronization is performed to synchronously update status of the first MPDU queue Q0 and the second MPDU queue Q1 by holding the MPDUs (M2, M3 and M4) and identifying the end time of the second PPDU P2.

In FIG. 6, after adjustment of the end time of the PPDU, the inter-chip synchronization steps 630 and 640 by the second chip C1 are staggered from the inter-chip synchronization steps 650 and 660 by the first chip C0.

In FIG. 6, the PPDU end time may be adjusted by changing MPDU counts, padding or any valid mechanism.

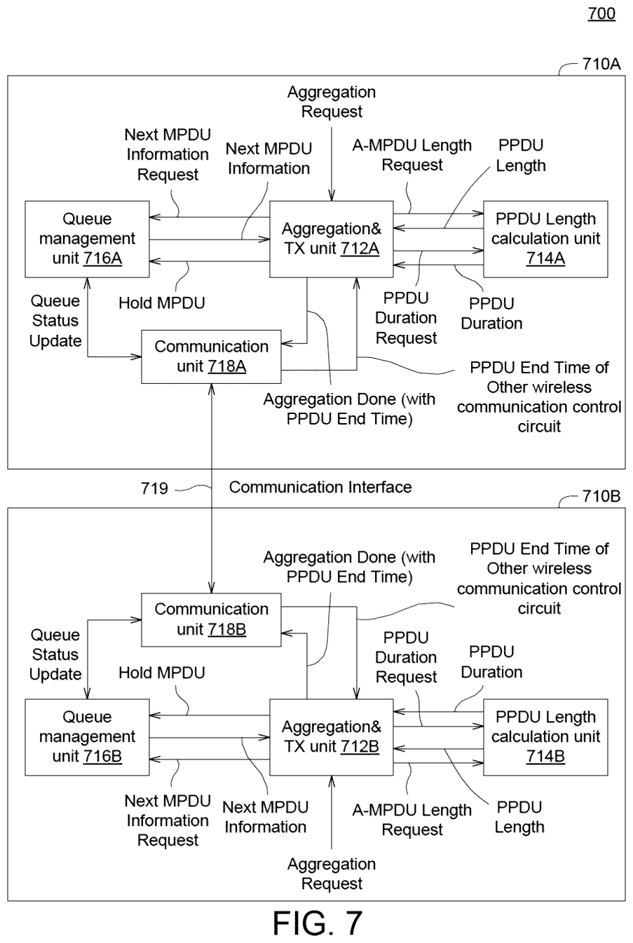

FIG. 7 shows a block diagram of a wireless communication device according to one embodiment of the application. The wireless communication device 700 may be for example but not limited by, Wi-Fi AP or Wi-Fi stations.

The wireless communication device 700 includes a first and a second wireless communication control circuits 710A and 710B. The chips C0 and C1 in FIG. 2 to FIG. 6 may be implemented by the first and the second wireless communication control circuits 710A and 710B. For wireless communication control, the first and the second wireless communication control circuits 710A and 710B may have the same or similar configuration and operations.

The first and the second wireless communication control circuits 710A and 710B include: aggregation and transmission units 712A and 712B, PPDU length calculation units 714A and 714B, queue management units 716A and 716B, communication units 718A and 718B. A communication interface 719 is between the first and the second wireless communication control circuits 710A and 710B. The aggregation and transmission units 712A and 712B are coupled to the PPDU length calculation units 714A and 714B, the queue management units 716A and 716B and the communication units 718A and 718B, respectively.

When there is a transmission (TX) opportunity, the aggregation and transmission units 712A and 712B perform MPDU aggregation to generate PPDU, and transmission of the PPDU is performed by the aggregation and transmission units 712A and 712B within the specified time.

The PPDU length calculation units 714A and 714B are for calculating the length of the aggregated MPDU (also referred as A-MPDU) or the duration of the PPDU. Also the PPDU length calculation units 714A and 714B convert between the byte length of the packet size (of the A-MPDU) and the duration of the PPDU. In general, a PPDU includes header information and the aggregated MPDU(s).

The queue management units 716A and 716B are for managing and synchronizing the MPDU queue.

The communication units 718A and 718B send synchronization information to the other wireless communication control circuit, send the updated queue status to the queue management units 716A and 716B, and send the PPDU end time from the aggregation and transmission units 712A and 712B to the other wireless communication control circuit.

Overall operations of the first and the second wireless communication control circuits 710A and 710B are as follows.

For simplicity, the case of transmission PPDU by the first wireless communication control circuit 710A is described.

When transmission begins, an aggregation request is sent to the aggregation and transmission unit 712A. If there is no PPDU end time received from the second wireless communication control circuit 710B, the aggregation and transmission unit 712A sends a “next MPDU information request” to the queue management unit 716A. In response to the “next MPDU information request”, the queue management unit 716A provides “next MPDU information” about the next MPDU (i.e., which MPDU is to be aggregated) to the aggregation and transmission unit 712A. Based on internal logic of the aggregation and transmission unit 712A, the aggregation and transmission unit 712A decides whether to aggregate the next MPDU into the PPDU. If the next MPUD is aggregated, the aggregation and transmission unit 712A sends a “Hold MPDU” command to the queue management unit 716A to hold the relevant MPDUs in the MPDU queue. Once the MPDUs for aggregation are selected, the total length of the aggregated MPDUs is calculated by the aggregation and transmission unit 712A. The aggregation and transmission unit 712A sends a “PPDU duration request” (which indicating the A-MPDU length) to the PPDU length calculation unit 714A. In response to the “PPDU duration request”, based on the current Wi-Fi communication mode, the PPDU length calculation unit 714A determines the PPDU duration information and reports back to the aggregation and transmission unit 712A. Using the PPDU duration information, the aggregation and transmission unit 712A obtains the PPDU end time.

The aggregation and transmission unit 712A informs the communication unit 718A about completion of aggregation along with the PPDU end time. The communication unit 718A queries the queue management unit 716A for an updated queue status (e.g., which MPDUs are currently on hold) and sends the synchronization information (including PPDU end time and MPDU queue status) to the other wireless communication control circuit. By so, the wireless communication control circuit 710A completes aggregation, transmission and queue status synchronization.

Now, details about receiving synchronization information from the other wireless communication control circuit are described.

The communication unit 718A forwards the updated queue status information (i.e., which MPDUs are currently on hold or released) of the synchronization information received from the other wireless communication control circuit to the queue management unit 716A and forwards the received PPDU end time of the received synchronization information to the aggregation and transmission unit 712A. When the aggregation and transmission unit 712A has a TX opportunity, the aggregation and transmission unit 712A receives an aggregation request. The aggregation and transmission unit 712A determines the synchronization collision period based on the received PPDU end time, and determines the PPDU duration which does not end in the synchronization collision period. The aggregation and transmission unit 712A sends the PPDU duration to the PPDU length calculation unit 714A. The PPDU length calculation unit 714A, based on the current communication mode, calculates an A-MPDU length lower bound and an A-MPDU length upper bound and forwards the A-MPDU length lower bound and the A-MPDU length upper bound to the aggregation and transmission unit 712A. That is, the A-MPDU length lower bound and the A-MPDU length upper bound are respectively corresponding to the start and the end of the synchronization collision duration. The aggregation and transmission unit 712A queries the queue management unit 716A about the next MPDU information, deciding which MPDUs to aggregate and notifying the queue management unit 716A to hold the selected MPDUs. Based on the A-MPDU length lower bound and the A-MPDU length upper bound, the aggregation and transmission unit 712A aggregates the selected MPDU(s) and adjusts the PPDU end time to be before the start of the synchronization collision period or after the end of the synchronization collision period for avoiding synchronization collisions. The aggregation and transmission unit 712A sends a “PPDU duration request” (which indicating the A-MPDU length) to the PPDU length calculation unit 714A. In response to the “PPDU duration request”, based on the current Wi-Fi communication mode, the PPDU length calculation unit 714A determines the PPDU duration information and reports back to the aggregation and transmission unit 712A. Using the PPDU duration information, the aggregation and transmission unit 712A obtains the PPDU end time. The aggregation and transmission unit 712A informs the communication unit 718A about completion of aggregation along with the PPDU end time. The communication unit 718A queries the queue management unit 716A for queue status updates (such as which MPDUs are currently on hold) and sends the synchronization information (including PPDU end time and queue status) to the other wireless communication control circuit. In the following, the A-MPDU may be also referred as a payload of the PPDU.

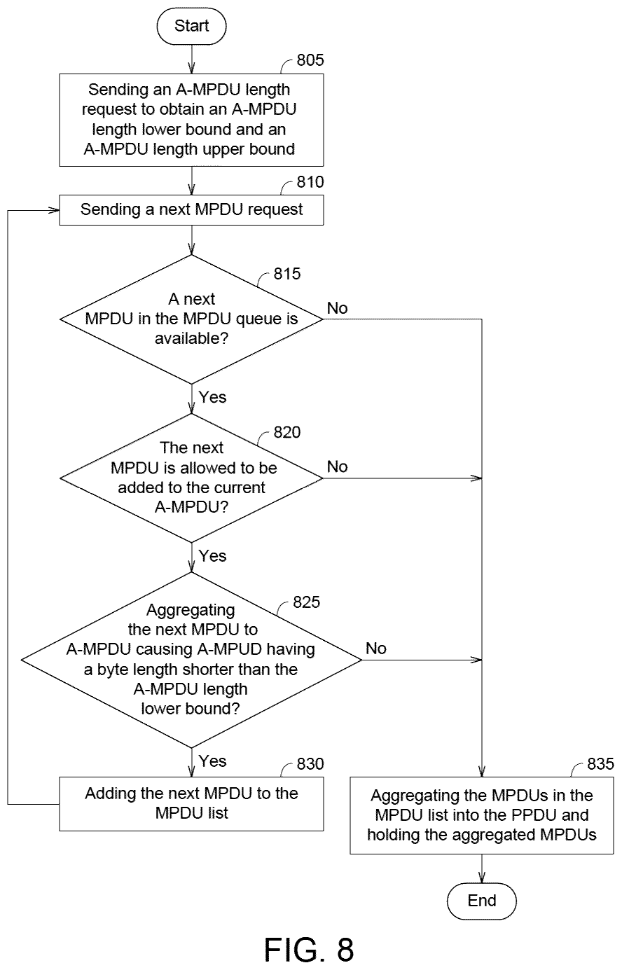

FIG. 8 shows a wireless communication method according to one embodiment of the application, wherein the PPDU end time is adjusted to be before the start of the synchronization collision period for avoiding synchronization collisions. FIG. 8 is performed by the aggregation and transmission unit.

In step 805, an A-MPDU length request is sent from the aggregation and transmission unit to the PPDU length calculation unit in response that the aggregation and transmission unit obtains another PPDU end time from the other wireless communication control circuit. In response to this, the PPDU length calculation unit sends the A-MPDU length lower bound and the A-MPDU length upper bound back to the aggregation and transmission unit. That is, if the MPDUs (A-MPDU) aggregated by the aggregation and transmission unit has a byte length falling within the A-MPDU length lower bound and the A-MPDU length upper bound, then the following inter-chip synchronization corresponding to the PPDU transmission will cause synchronization collision.

In step 810, a next MPDU request is sent from the aggregation and transmission unit to the queue management unit.

In step 815, the aggregation and transmission unit checks whether a next MPDU in the MPDU queue is available. When a next MPDU in the MPDU queue is available (which means the MPDU queue is not empty), the flow proceeds to the step 820. When a next MPDU in the MPDU queue is not available (which means the MPDU queue is already empty), the flow proceeds to the step 835.

In step 820, the aggregation and transmission unit checks whether the next MPDU is allowed to be added to the current A-MPDU based on system requirements or other criteria. When step 820 is yes, the flow proceeds to step 825. When step 820 is no, the flow proceeds to step 835.

In step 825, the aggregation and transmission unit checks whether aggregating the next MPDU to the A-MPDU of the PPDU causes the aggregated MPDUs (A-MPDU) having a byte length shorter than the A-MPDU length lower bound to determine whether adding the next MPDU to the A-MPDU causes the synchronization collision. If no in step 825, which means adding the next MPDU to the A-MPDU causes synchronization collision, the aggregation and transmission unit decides not to add the next MPDU to the A-MPDU and the flow proceeds to step 835. If yes in step 825, the aggregation and transmission unit decides to add the next MPDU to the MPDU list in step 830. After the step 830, the flow returns to the step 810. The MPDU in the MPDU list is to be aggregated into the A-MPDU of the PPDU.

In step 835, the aggregation and transmission unit aggregates the MPDUs in the MPDU list into the A-MPDU of the PPDU and holds the aggregated MPDUs. After step 835, the A-MPDU of the PPDU has the byte length shorter than the A-MPDU length lower bound, which means that the PPDU has the end time before the end of the synchronization collision period and the synchronization collision is prevented.

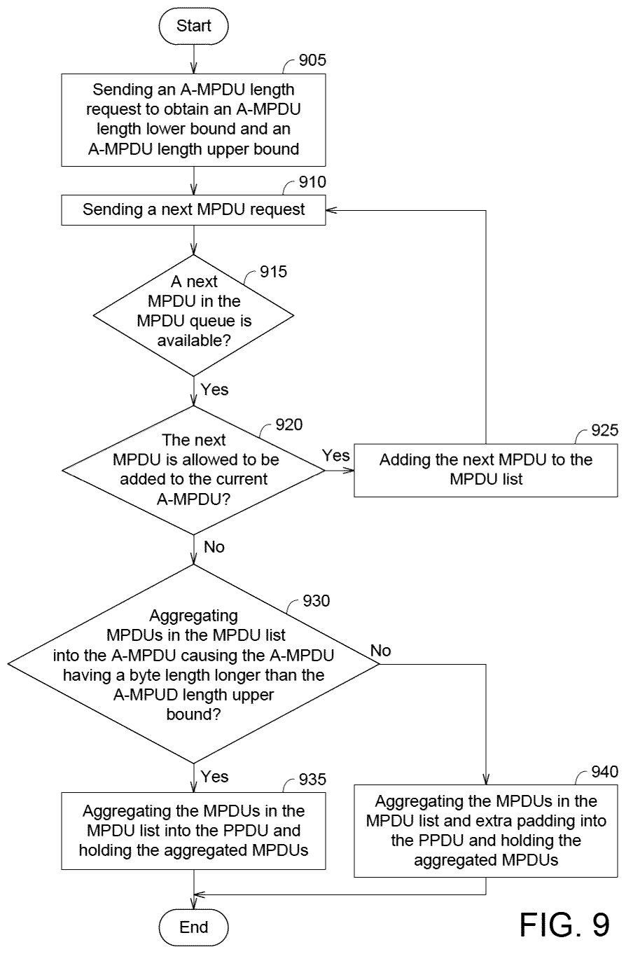

FIG. 9 shows a wireless communication method according to one embodiment of the application, wherein the PPDU end time is adjusted to be after the end of the synchronization collision period for avoiding synchronization collisions. FIG. 9 is performed by the aggregation and transmission unit.

Steps 905, 910, 915 and 920 are similar to steps 805, 810, 815 and 820. When step 920 is yes, the flow proceeds to step 925. When step 920 is no, the flow proceeds to step 930.

In step 925, the aggregation and transmission unit decides to add the next MPDU to the MPDU list.

In step 930, the aggregation and transmission unit checks whether aggregating MPDUs in the MPDU list into the A-MPDU causes the A-MPDU having a byte length longer than the A-MPUD length upper bound to determine whether the PPDU causes the synchronization collision. If yes in step 930, the flow proceeds to step 935. If no in step 930, the flow proceeds to step 940.

In step 935, the aggregation and transmission unit aggregates the MPDUs in the MPDU list into the PPDU and holds the aggregated MPDUs. After step 935, the A-MPDU of the PPDU has the byte length longer than the A-MPDU length upper bound, which means that the PPDU has the end time after the end of the synchronization collision period and the synchronization collision is prevented.

In step 940, the aggregation and transmission unit aggregates the MPDUs in the MPDU list and extra padding into the PPDU and holds the aggregated MPDUs. After step 940, the PPDU has the end time after the end of the synchronization collision period and the synchronization collision is prevented.

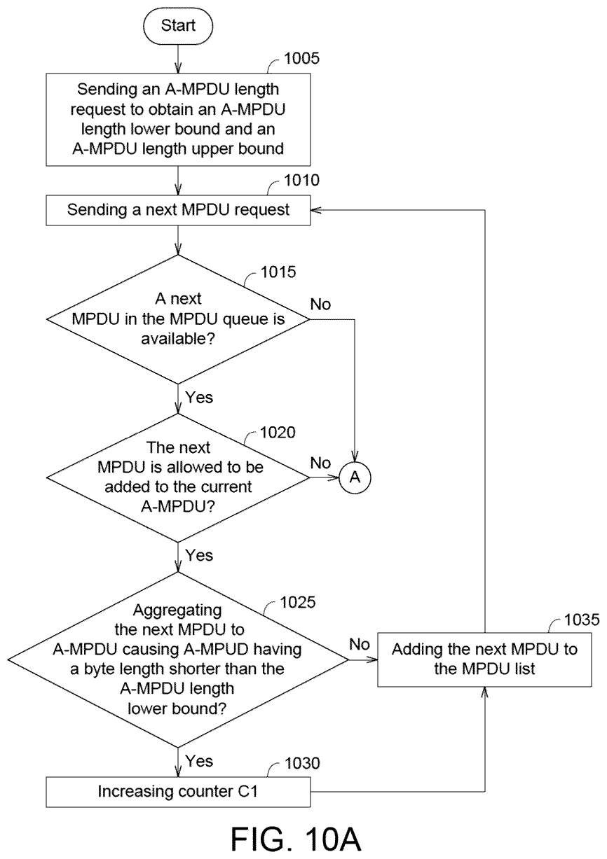

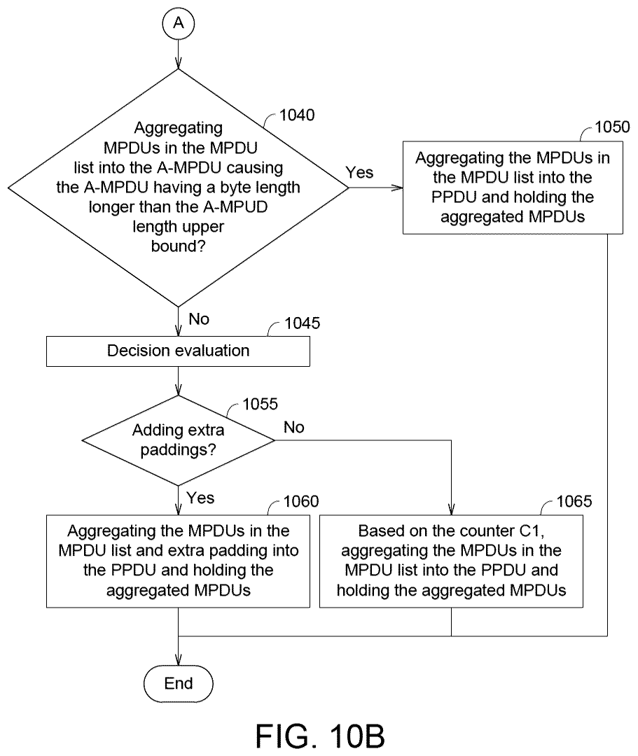

FIG. 10A and FIG. 10B show a wireless communication method according to one embodiment of the application, wherein the PPDU end time is adjusted to be either before the start of the synchronization collision period or after the end of the synchronization collision period for avoiding synchronization collisions. FIG. 10A and FIG. 10B are performed by the aggregation and transmission unit. In other words, FIG. 10A and FIG. 10B show a mixed version of the flows in FIG. 8 and FIG. 9.

Steps 1005 and 1010 are the same or similar to steps 805, 810, 905 and 910, and thus the details thereof are omitted.

Steps 1015, 1020 and 1025 are the same or similar to steps 815, 820 and 825, and thus the details thereof are omitted. If yes in step 1025, the flow proceeds to step 1030. If no in step 1025, the flow proceeds to step 1035.

In step 1030, a counter C1 is increased.

In step 1035, the aggregation and transmission unit decides to add the next MPDU to the MPDU list. After step 1035, the flow returns to step 1010.

Step 1040 is the same or similar to the step 930. If yes in step 1040, the flow proceeds to step 1050. If no in step 1040, the flow proceeds to step 1045.

In step 1050, the aggregation and transmission unit aggregates the MPDUs in the MPDU list into the PPDU and holds the aggregated MPDUs. After step 1050, the A-MPDU of the PPDU has the byte length longer than the A-MPDU length upper bound, which means that the PPDU has the end time after the end of the synchronization collision period and the synchronization collision is prevented.

In step 1045, a decision evaluation is performed by the aggregation and transmission unit. The decision evaluation is for deciding whether the A-MPDU of the PPDU has the byte length shorter than the A-MPDU length lower bound or longer than the A-MPDU length upper bound, which means for deciding whether the end time of the PPDU is to be either before the start of the synchronization collision period or after the end of the synchronization collision period. The decision evaluation is also for deciding that whether aggregating all MPUDs in the MPDU list causes the A-MPDU has a byte length closer to either the A-MPDU length lower bound or the A-MPDU length upper bound. When aggregating all MPUDs in the MPDU list causes the A-MPDU has a byte length closer to the A-MPDU length lower bound, then it is decided to aggregate the MPDUs in the MPDU list based on the counter C1 and thus the A-MPUD has a byte length shorter than the A-MPUD length lower bound. On the contrary, when aggregating all MPUDs in the MPDU list causes the A-MPDU has a byte length closer to the A-MPDU length upper bound, then it is decided to aggregate all the MPDUs in the MPDU list and adding extra paddings. Thus the A-MPUD has a byte length longer than the A-MPUD length upper bound.

In step 1055, the aggregation and transmission unit decides whether to add paddings based on the decision of step 1045. If yes in step 1055, the flow proceeds to step 1060. If no in step 1055, the flow proceeds to step 1065.

In step 1060, the aggregation and transmission unit aggregates the MPDUs in the MPDU list and extra padding into the PPDU and holds the aggregated MPDUs. After step 1060, the A-MPDU of the PPDU has the byte length longer than the A-MPDU length upper bound, which means that the end time of the PPDU is after the end of the synchronization collision period.

In step 1065, based on the counter C1, the aggregation and transmission unit aggregates the MPDUs in the MPDU list into the PPDU and holds the aggregated MPDUs. For example, when the counter C1 is three, the aggregation and transmission unit aggregates the first three not-held MPDUs in the MPDU list into the PPDU and holds the aggregated MPDUs. After step 1065, the A-MPDU of the PPDU has the byte length shorter than the A-MPDU length lower bound, which means that the end time of the PPDU is before the start of the synchronization collision period.

In one embodiment of the application, by adjusting the end time of the PPDU to be before the start of the synchronization collision period or after the end of the synchronization collision period, the synchronization collision is prevented. Thus, the multi-chip MLO wireless communication device and method of one embodiment of the application can synchronize the MPDU queue status before any of other chips starts the aggregation for next TX even when a middle performance (middle cost) inter-chip interface is used.

The above primarily describes the solutions provided in the embodiments of the present application from the perspective of feature extraction. It is understood that to achieve the above functions, the wireless communication device includes corresponding hardware structures and/or software modules that execute functions. Professionals in the technical field can easily recognize that the units and algorithm steps described in the embodiments of the present application can be implemented in hardware form or a combination of hardware and algorithms. Whether the functions are performed by hardware or by algorithms depend on the specific application and design constraints of the technical solution. Professionals in the technical field can use different methods to implement the functions described in each specific application without departing from the scope of the present application.

In one embodiment of the present application, the wireless communication device can be divided into functional modules based on the aforementioned method examples. For instance, each functional module can be obtained by dividing according to each corresponding function, or two or more functions can be integrated into one processing module. The integrated module can be implemented in hardware form or as a software functional module. It should be noted that in the embodiments of the present application, the division into modules is merely an example and is a logical function division. In the actual implementation process, other division methods can be used.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of a sub-combination. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A multi-link operation wireless communication method applicable to a wireless communication device having a first wireless communication control circuit and a second wireless communication control circuit, the multi-link operation wireless communication method comprising:
receiving a first synchronization information from the first wireless communication control circuit to the second wireless communication control circuit, the first synchronization information including a first updated status of a first packet queue of the first wireless communication control circuit and an end time of a first transmission packet to be transmitted by the first wireless communication control circuit over a first link;
generating a synchronization collision period by the second wireless communication control circuit based on the end time of the first transmission packet; and
aggregating, by the second wireless communication control circuit, a plurality of data packets into a second transmission packet which is transmitted over a second link, wherein the second wireless communication control circuit adjusts an end time of the second transmission packet as either before a start of the synchronization collision period or after an end of the synchronization collision period.

2. The multi-link operation wireless communication method according to claim 1, wherein
after the second wireless communication control circuit obtains the end time of the first transmission packet, the second wireless communication control circuit estimates a synchronization time that the second wireless communication control circuit takes to complete synchronization based on capabilities of the second wireless communication control circuit; and
the synchronization collision period is determined based on hardware capabilities and the end time of the first transmission packet.

3. The multi-link operation wireless communication method according to claim 1, wherein in response to that the end time of the second transmission packet is either before the start of the synchronization collision period or after the end of the synchronization collision period, a second inter-chip synchronization time of the second wireless communication control circuit is staggered from a first inter-chip synchronization time of the first wireless communication control circuit.

4. The multi-link operation wireless communication method according to claim 1, wherein the end time of the second transmission packet is adjusted by changing data packet counts and/or adding extra padding.

5. The multi-link operation wireless communication method according to claim 1, wherein
in response that to aggregate a next data packet to the second transmission packet causes a byte length of aggregated data packets of the second transmission packet to be shorter than a length lower bound, the next data packet is added to a data packet list; and
data packets in the data packet list are aggregated into the second transmission packet and the aggregated data packets in the data packet list are held, wherein after aggregation, the end time of the second transmission packet is before the start of the synchronization collision period.

6. The multi-link operation wireless communication method according to claim 1, wherein
in response to a first determination that aggregating all data packets in a data packet list into the second transmission packet causes a byte length of aggregated data packets of the second transmission packet to be longer than a length upper bound, the data packets in the data packet list are aggregated into the second transmission packet and the aggregated data packets in the data packet list are held, wherein after aggregation, the end time of the second transmission packet is after the end of the synchronization collision period; and
in response to a second determination that aggregating the data packets in the data packet list into the second transmission packet causes the byte length of the aggregated data packets of the second transmission packet to be shorter than the length upper bound, the data packets in the data packet list and extra paddings are aggregated into the second transmission packet and the aggregated data packets in the data packet list are held, wherein after aggregation, the end time of the second transmission packet is after the end of the synchronization collision period.

7. The multi-link operation wireless communication method according to claim 1, wherein
in response that to aggregate a next data packet to the second transmission packet causes a byte length of aggregated data packets of the second transmission packet to be shorter than a length lower bound, a counter is increased and the next data packet is added to a data packet list;
in response that to aggregate the next data packet to the second transmission packet causes the byte length of the aggregated data packets of the second transmission packet to be longer than a length upper bound, data packets in the data packet list are aggregated into the second transmission packet and the aggregated data packets in the data packet list are held, wherein after aggregation, the end time of the second transmission packet is after the end of the synchronization collision period;
a decision evaluation is performed to decide whether to add extra paddings;
in response to deciding to add extra paddings, the data packets in the data packet list and extra paddings are aggregated into the second transmission packet and the aggregated data packets in the data packet list are held, wherein after aggregation, the end time of the second transmission packet is after the end of the synchronization collision period; and
in response to deciding not to add extra paddings, based on the counter, the data packets in the data packet list are aggregated into the second transmission packet and the aggregated data packets in the data packet list are held, wherein after aggregation, the end time of the second transmission packet is before the start of the synchronization collision period.

8. A multi-link operation wireless communication device including:
a first wireless communication control circuit, and
a second wireless communication control circuit coupled to the first wireless communication control circuit,
both the first and the second wireless communication control circuits being configured for:
receiving a first synchronization information from the other one among the first and the second wireless communication control circuits, the first synchronization information including a first updated status of a first packet queue and an end time of a first transmission packet to be transmitted by either the first wireless communication control circuit over a first link or the second wireless communication control circuit over a second link;
generating a synchronization collision period based on the end time of the first transmission packet; and
aggregating a plurality of data packets into a second transmission packet which is transmitted over the second link, wherein an end time of the second transmission packet is adjusted to be either before a start of the synchronization collision period or after an end of the synchronization collision period.

9. The multi-link operation wireless communication device according to claim 8, wherein both the first and the second wireless communication control circuits being configured for:
after obtaining the end time of the first transmission packet, estimating a synchronization time for completing synchronization based on capabilities of either the first wireless communication control circuit or the second wireless communication control circuit; and
the synchronization collision period is determined based on hardware capabilities and the end time of the first transmission packet.

10. The multi-link operation wireless communication device according to claim 8, wherein both the first and the second wireless communication control circuits being configured for:
in response to that the end time of the second transmission packet is either before the start of the synchronization collision period or after the end of the synchronization collision period, a second inter-chip synchronization time of the second wireless communication control circuit is staggered from a first inter-chip synchronization time of the first wireless communication control circuit.

11. The multi-link operation wireless communication device according to claim 8, wherein both the first and the second wireless communication control circuits being configured for:
adjusting the end time of the second transmission packet by changing data packet counts and/or adding extra padding.

12. The multi-link operation wireless communication device according to claim 8, wherein both the first and the second wireless communication control circuits being configured for:
in response that to aggregate a next data packet to the second transmission packet causes a byte length of aggregated data packets of the second transmission packet to be shorter than a length lower bound, the next data packet is added to a data packet list; and
data packets in the data packet list are aggregated into the second transmission packet and the aggregated data packets in the data packet list are held, wherein after aggregation, the end time of the second transmission packet is before the start of the synchronization collision period.

13. The multi-link operation wireless communication device according to claim 8, wherein both the first and the second wireless communication control circuits being configured for:
in response to a first determination that aggregating all data packets in a data packet list into the second transmission packet causes a byte length of aggregated data packets of the second transmission packet to be longer than a length upper bound, the data packets in the data packet list are aggregated into the second transmission packet and the aggregated data packets in the data packet list are held, wherein after aggregation, the end time of the second transmission packet is after the end of the synchronization collision period; and
in response to a second determination that aggregating the data packets in the data packet list into the second transmission packet causes the byte length of the aggregated data packets of the second transmission packet to be shorter than the length upper bound, the data packets in the data packet list and extra paddings are aggregated into the second transmission packet and the aggregated data packets in the data packet list are held, wherein after aggregation, the end time of the second transmission packet is after the end of the synchronization collision period.

14. The multi-link operation wireless communication device according to claim 8, wherein both the first and the second wireless communication control circuits being configured for:
in response that to aggregate a next data packet to the second transmission packet causes a byte length of aggregated data packets of the second transmission packet to be shorter than a length lower bound, a counter is increased and the next data packet is added to a data packet list;
in response that to aggregate the next data packet to the second transmission packet causes the byte length of the aggregated data packets of the second transmission packet to be longer than a length upper bound, data packets in the data packet list are aggregated into the second transmission packet and the aggregated data packets in the data packet list are held, wherein after aggregation, the end time of the second transmission packet is after the end of the synchronization collision period;
a decision evaluation is performed to decide whether to add extra paddings;
in response to deciding to add extra paddings, the data packets in the data packet list and extra paddings are aggregated into the second transmission packet and the aggregated data packets in the data packet list are held, wherein after aggregation, the end time of the second transmission packet is after the end of the synchronization collision period; and
in response to deciding not to add extra paddings, based on the counter, the data packets in the data packet list are aggregated into the second transmission packet and the aggregated data packets in the data packet list are held, wherein after aggregation, the end time of the second transmission packet is before the start of the synchronization collision period.

15. The multi-link operation wireless communication device according to claim 8, wherein
each of the first and the second wireless communication control circuits includes: an aggregation and transmission unit, a PPDU (Physical Layer Protocol Data Unit) length calculation unit, a queue management unit, and an communication unit, the aggregation and transmission unit being coupled to the transmission packet length calculation unit, the queue management unit and the communication unit, and
a communication interface is between the first and the second wireless communication control circuits.

16. The multi-link operation wireless communication device according to claim 15, wherein
when there is a transmission opportunity, the aggregation and transmission unit perform MPDU (MAC (Media Access Control) Protocol Data Unit) aggregation to generate a PPDU, and transmission of the PPDU is performed by the aggregation and transmission unit within a specified time;
the PPDU length calculation unit calculates a length of aggregated MPDUs of the PPDU or a duration of the PPDU, and the PPDU length calculation unit converts between the length of the aggregated MPDUs of the PPDU and the duration of the PPDU;
the queue management unit manages and synchronizes a MPDU queue; and
the communication unit sends synchronization information to the other wireless communication control circuit, sends an updated queue status to the queue management unit, and sends the PPDU end time from the aggregation and transmission unit to the other wireless communication control circuit.

17. The multi-link operation wireless communication device according to claim 16, wherein
an aggregation request is sent to the aggregation and transmission unit;
in response that there is no PPDU end time received from the second wireless communication control circuit, the aggregation and transmission unit sends a “next MPDU information request” to the queue management unit;
in response to the “next MPDU information request”, the queue management unit provides “next MPDU information” about the next MPDU to the aggregation and transmission unit;
based on internal logic of the aggregation and transmission unit, the aggregation and transmission unit decides whether to aggregate the next MPDU into the PPDU;
in response to the next MPDU is aggregated, the aggregation and transmission unit sends a “Hold MPDU” command to the queue management unit to hold relevant MPDUs in the MPDU queue;
in response to that the MPDUs for aggregation are selected, a total length of the MPDUs is calculated by the aggregation and transmission unit;
the aggregation and transmission unit sends a “PPDU duration request” to the PPDU length calculation unit;
in response to the “PPDU duration request”, based on a current communication mode, the PPDU length calculation unit determines PPDU duration information and reports back to the aggregation and transmission unit;
based on the PPDU duration information, the aggregation and transmission unit obtains the PPDU end time;
the aggregation and transmission unit informs the communication unit about completion of aggregation along with the PPDU end time; and
the communication unit queries the queue management unit for an updated queue status and sends the synchronization information including the PPDU end time and the MPDU queue status to the other wireless communication control circuit.

18. The multi-link operation wireless communication device according to claim 17, wherein
the communication unit forwards the updated queue status information of the synchronization information received from the other wireless communication control circuit to the queue management unit and forwards the PPDU end time of the synchronization information to the aggregation and transmission unit;
in response that the aggregation and transmission unit has transmission opportunity, the aggregation and transmission unit receives an aggregation request;
the aggregation and transmission unit determines the synchronization collision period based on the received PPDU end time, and determines the PPDU duration which does not end in the synchronization collision period;
the aggregation and transmission unit sends the PPDU duration to the PPDU length calculation unit;
based on a current communication mode, the PPDU length calculation unit calculates a length lower bound and a length upper bound and forwards the length lower bound and the length upper bound to the aggregation and transmission unit;
the aggregation and transmission unit queries the queue management unit about the next MPDU information, deciding which MPDUs to aggregate and notifying the queue management unit to hold the selected MPDUs;
based on the length lower bound and the length upper bound, the aggregation and transmission unit aggregates the selected MPDU(s) and adjusts the PPDU end time to be before the start of the synchronization collision period or after the end of the synchronization collision period;
the aggregation and transmission unit sends a “PPDU duration request” to the PPDU length calculation unit;
in response to the “PPDU duration request”, based on a current communication mode, the PPDU length calculation unit determines PPDU duration information and reports back to the aggregation and transmission unit;
based on the PPDU duration information, the aggregation and transmission unit obtains the PPDU end time;
the aggregation and transmission unit informs the communication unit about completion of aggregation along with the PPDU end time; and
the communication unit queries the queue management unit for queue status update and send the synchronization information including the PPDU end time and the queue status to the other wireless communication control circuit.
